(19) United States
(12) Patent Application Publication
(10) Pub. No.: US 2005/0042577 A1
(43) Pub. Date: Feb. 24, 2005

(54) Dental crown forms and methods

(76) Inventors: James R. Kvitrud, White Bear Lake, MN (US); Kevin M. Cummings, Little Canada, MN (US); Naimul Karim, Maplewood, MN (US)

Correspondence Address: Eloise J Maki Esq;3M Innovative Properties Company, Office of Intellectual Property Counsel, P O Box 33427, St Paul, MN, 55133-3427, US

(21) Appl. No.: 10/643,771

(22) Filed: Aug. 19, 2003

(51) Int. Cl. A61C 5/08

(52) U.S. Cl. 433/218

(57) ABSTRACT

Dental crown forms and methods of using them are disclosed. The dental crown forms may include one or more of the following features: a handle attached to the dental crown form at a location removed from the base of the dental crown form; a vented handle through which excess amounts of hardenable dental material can pass during placement of the crown form; and one or more lines of weakness that may be separated to remove a dental crown form from hardenable dental material after placement of the filled crown form. The dental crown forms may also be located in packages with hardenable dental material located within the dental crown forms as packaged.

### BACKGROUND

Dental crown forms are available as stock items for use in providing shape to dental restorative materials. For a variety of reasons, dentists fill the dental crown forms with dental restorative material shortly before placing the crown forms over teeth to be restored. Among those reasons are that often the dental restorative material is mixed to obtain a desired shade or color to match the tooth or teeth being restored or the surrounding teeth. Another reason is that the dental restorative material may have a limited working life once exposed to ambient air, moisture, light, etc. Examples of dental crown forms include those described in, e.g., U.S. Pat. No. 4,129,946 (Kennedy); U.S. Pat. No. 5,487,663 (Wilson); U.S. Pat. No. 5,951,294 (Pierson), etc.

Another issue with dental crown forms is handling of the filled dental crown forms during placement in the mouth. Some dental crown forms, such as those described in U.S. Pat. No. 4,129,946 (Kennedy) include a tab on the gingival end of the crown form to assist in handling of the form during filling and placement.

### SUMMARY OF THE INVENTION

The present invention provides dental crown forms that may include one or more of the following features: a handle attached to the dental crown form at a location removed from the base of the dental crown form; a vented handle through which excess amounts of hardenable dental material can pass during placement of the crown form; and one or more lines of weakness that may be separated to remove a dental crown form from the dental material after placement of the filled crown form on a prepared tooth.

Among the potential advantages that may be associated with handles attached to dental crown form at a location removed from the base of the dental crown form is simplified handling of the crown form because of better access to the handle during placement on a tooth. Also, as compared to handles that extend from the base of a dental crown form, placement of the handle in an area away from the base or gingival region may avoid interference with gingival tissue during the restoration process.

The potential advantages of a vented handle on the dental crown form may include, for example, the ability to remove excess amounts of the hardenable dental material at a location removed from the gingival region. Another potential advantage as compared to known vented dental crown forms is that the vented material may preferably be retained within the handle as opposed to being present on the outer surface of the crown form.

A potential advantage of dental crown forms including one or more lines of weakness is that removal of the dental crown form before or after hardening may be accomplished without requiring cutting of the crown form without an instrument.

It may be preferred that the dental crown forms of the present invention be packaged as a pre-filled dental crown form with hardenable dental material located therein. Potential advantages of providing pre-filled dental crown forms may include reductions in the time required to restore a tooth because the dentist does not need to fill the dental crown form before use.

Another potential advantage is that, if the hardenable dental material is of a type that can retain its desired shape before hardening and after removal of the dental crown form, the practitioner may remove the dental crown form while leaving the unhardened dental material in place on the prepared tooth. As such, the practitioner may have an opportunity to shape the hardenable dental material before hardening to, e.g., adjust occlusal, proximal, and/or marginal contacts with the unhardened dental material in its intended location, after which the properly shaped hardenable dental material can be hardened.

In one aspect, the present invention provides a dental crown form including a body defining a tooth-shaped volume, the body having a base and an incisal/occlusal region distal from the base; hardenable dental material located within the tooth-shaped volume; and a handle attached to the body at a location removed from the base.

In another aspect, the present invention provides a dental crown form including a body defining a tooth-shaped volume, the body having a base and an incisal/occlusal region distal from the base; hardenable dental material located within the tooth-shaped volume; a hollow handle attached to the body at a location that is closer to the incisal/occlusal region than the base, wherein the handle defines a handle volume that is in fluid communication with the tooth-shaped volume of the body through a vent opening formed in the body.

In another aspect, the present invention provides a dental crown form including a body defining a tooth-shaped volume, the body having a base and an incisal/occlusal region distal from the base; and a hollow handle attached to the body at a location removed from the base, wherein the hollow handle is in fluid communication with the tooth-shaped volume through a vent opening formed in the body.

In another aspect, the present invention provides a dental crown form including a body defining a tooth-shaped volume, the body having a base and an incisal/occlusal region distal from the base; and one or more lines of weakness formed in the body.

In another aspect, the present invention provides a method of providing a dental crown by providing a dental crown form that includes a body defining a tooth-shaped volume, the body having a base and an incisal/occlusal region distal from the base, wherein the dental crown form further includes a handle attached to the body at a location removed from the base; providing hardenable dental material located within the tooth-shaped volume of the body; locating the dental crown form over a prepared tooth; hardening the hardenable dental material to form a dental crown; and removing the dental crown form.

In another aspect, the present invention provides a method of providing a dental crown by providing a dental crown form that comprises a body defining a tooth-shaped volume, the body having a base and an incisal/occlusal region distal from the base, the dental crown form further including one or more lines of weakness formed in the body; providing hardenable dental material located within the tooth-shaped volume of the body; locating the dental crown form over a prepared tooth; hardening the hardenable dental material to form a dental crown; and removing the dental crown form by separating the one or more lines of weakness.

These and other features and advantages of the present invention may be described in more detail in connection with various illustrative embodiments of the invention below.

### BRIEF DESCRIPTION OF THE DRAWINGS

FIG. 1 is a view of the labial surface of one dental crown form according to the present invention including a handle.

FIG. 2 is a cross-sectional view of the dental crown form of FIG. 1 taken along line 2-2 in FIG. 1.

FIG. 3 is a cross-sectional view of the dental crown form of FIG. 2 after placement on a prepared tooth.

FIG. 4 is a view of an interproximal surface of another dental crown form according to the present invention illustrating a line of weakness formed therein.

FIG. 5 is a side view of the dental crown form of FIG. 4 after separation along the lines of weakness in the dental crown form.

FIG. 6 is a view of an interproximal surface of another dental crown form according to the present invention including a handle, tab, and line of weakness.

FIG. 7 is a cross-sectional view of an alternative dental crown form including an inner liner.

FIG. 8 is a view of an interproximal surface of the dental crown form of FIG. 7 including a line of weakness.

FIG. 9 is a schematic diagram illustrating a dental crown form according to the present invention filled with hardenable dental material and located within a sealed package.

### DETAILED DESCRIPTION OF ILLUSTRATIVE EMBODIMENTS OF THE INVENTION

In the following detailed description of illustrative embodiments, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention.

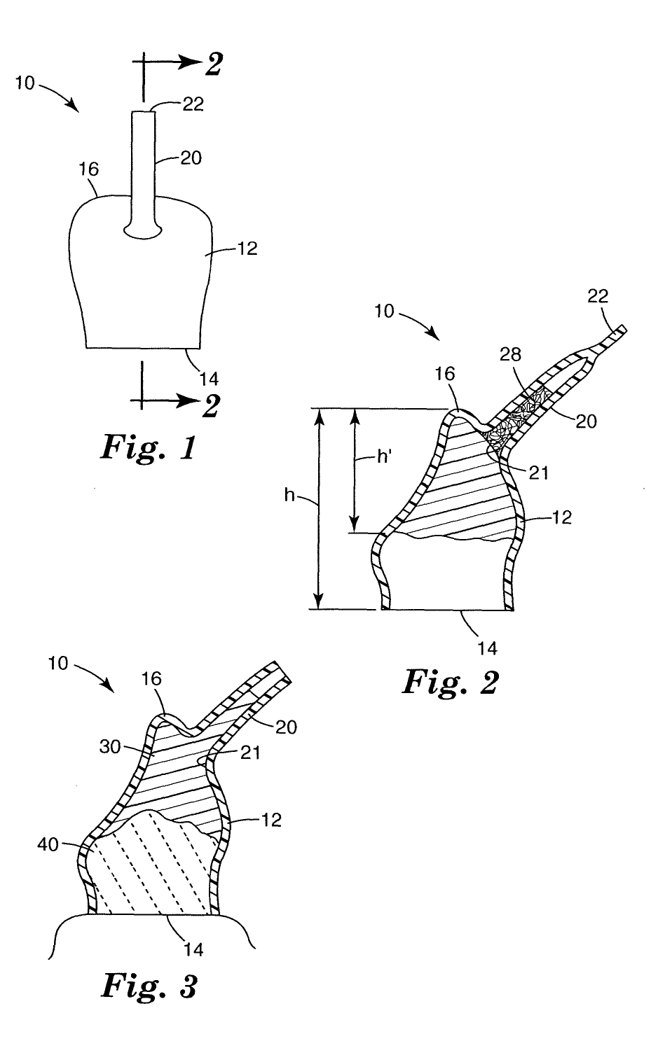

FIG. 1 is a view of one dental crown form, FIG. 2 is a cross-sectional view of the same dental crown form, and FIG. 3 is a cross-sectional view of the same dental crown form fitted over a prepared tooth. The dental crown form 10 includes a body 12 defining a tooth-shaped volume in its interior that is generally in the shape of the tooth to be restored. Because healthy teeth are found in a variety of anatomical shapes, the body 12 and its tooth-shaped volume may take a variety of anatomical shapes that correspond to those of healthy teeth. As such, those of skill in the art will recognize that the precise shape of the dental crown form 10 and its tooth-shaped volume will vary depending on the anatomical shape of the tooth to be repaired.

The body 12 includes a base 14 defining an opening through which a tooth to be restored is inserted. In anatomical terms, the base 14 can be correlated to the cervical/gingival region of an actual tooth. The dental crown form 10 also includes an incisal/occlusal region 16 located opposite the base 14.

The body 12 of the dental crown form 10 can be manufactured of any suitable material or materials that are structurally capable of maintaining the desired shape of a tooth. Examples of some suitable materials for the dental crown forms of the present invention include, but are not limited to polyacrylonitriles, polyesters, polyamides, polyureas, polyolefins, polystyrenes, etc.

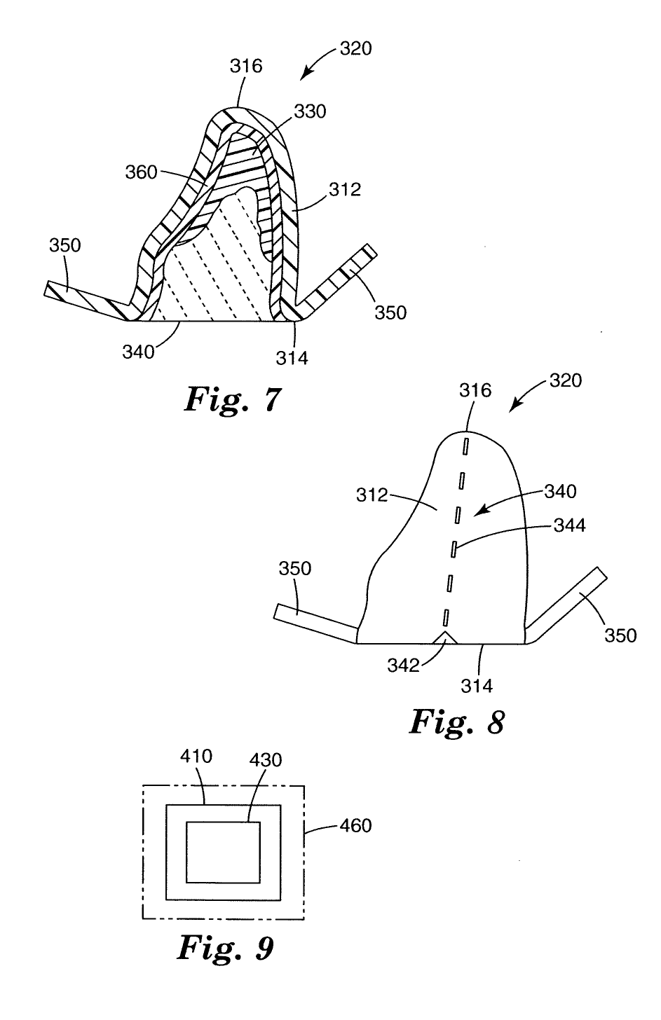

As manufactured, the body 12 may have one or more other preferred characteristics. For example, the interior surfaces of the body 12 may have desirable release characteristics for the hardenable dental materials used in connection with the dental crown forms. The release characteristics may be for hardened and/or unhardened dental materials. In some instances, it may be desirable to provide a different material (e.g., a release liner such as a PTFE film, etc.) within the interior of the body 12 to reduce or prevent adhesion between the dental crown form 10 and the hardenable dental material 30 located therein. One illustrative embodiment of a dental crown form including a liner is discussed below in connection with FIGS. 7 and 8.

Another potentially useful characteristic of the materials used for the body 12 of the dental crown forms 10 is transmissivity to actinic radiation used to cured some hardenable dental materials, i.e., the dental crown forms 10 may preferably allow a practitioner to harden the hardenable dental materials within the body 12 before the crown form 10 is removed.

Unlike the dental crown forms described in U.S. Pat. No. 4,129,946 (Kennedy) which include a flange around the base and a tab extending from the flange, the dental crown forms 10 of the present invention may preferably terminate in a simple lip around the base 14. A potential advantage of this construction is that the dental crown form 10 may be located in position within the mouth of a patient with a reduced likelihood of interference with any surrounding teeth and/or gum tissue.

The dental crown form 10 also includes a handle 20 extending from the body 12. It may be preferred that the handle 20 be attached to the body 12 at a location removed from the base 14. By “removed from the base” it is meant that the handle is attached to the body at a location that is not at the base 14, but is, rather, spaced from the base 14 by at least some distance. In the depicted embodiment, the handle 20 extends from the labial surface of the dental crown form 10 (slightly below the incisal/occlusal region 16). Alternatively, the handle 20 may extend directly from the incisal/occlusal region 16 or from the lingual surface or one of the interproximal side surfaces of the dental crown form 10. It may, however, be preferred that the handle 20 be attached to the body 12 on a labial or lingual surface as opposed to an interproximal side surface to facilitate manipulation and placement of the dental crown form 10 between neighboring teeth.

By providing a handle 20 that is attached to the dental crown form 10 at a location removed from the base 14, manipulation of the dental crown form 10 within the mouth of a patient during placement of the dental crown form 10 may be enhanced. It may be preferred that the handle 20 be attached to the dental crown form 10 at a location that is closer to the incisal/occlusal region 16 than the base 14. Referring to FIG. 2 in particular, the dental crown form 10 may be characterized as having an overall height h measured from the base 14 to the furthest point in the incisal/occlusal region 16. It may be preferred that the handle 20 be attached to the body 12 of the dental crown form 10 within a handle region h′ (see FIG. 2) that is defined as the outer surface of the dental crown form 10 within a distance h/2 from the furthest point in the incisal/occlusal region 16. It may be more preferred that the handle region h′ be defined as the outer surface of the dental crown form 10 within a distance h/3 from the furthest point in the incisal/occlusal region 16.

The handle 20 includes a tip 22 located distal from the body 12. The handle 20 may preferably be hollow, i.e., have a handle volume that is in fluid communication with the tooth-shaped volume of the body 12 through a vent opening 21 formed in the body 12. If hollow, the handle 20 may have a hollow tubular shape with any suitable cross-section, e.g., circular, oval, triangular, rectangular, etc.

The handle 20 may preferably be manufactured of the same materials as the body 12 of the dental crown form 10. For example, if the body 12 is a molded device, the handle 20 may preferably be molded with the body. Alternatively, the handle 20 may be attached to the body 12 after the body 12 has been manufactured. In either case, i.e., whether the handle 20 is molded or otherwise manufactured with the body 12 or whether the handle 20 is attached to the body 12 at a later time, it is preferred that the handles on dental crown forms of the present invention be fixedly attached to the body 12 such that some destructive operation, e.g., cutting, tearing, etc. be performed to separate the handle 20 (if desired) from the body 12.

If the handle 20 is hollow (as seen in FIG. 2) and fluid communication between the tooth-shaped volume of the body 12 and the handle volume of the handle 20 is desired, then a vent opening will need to be formed in the body 12 to provide that desired fluid communication.

As an alternative to a hollow handle 20 in fluid communication with the tooth-shaped volume of the body 12, the body 12 may include one or more vents formed therein through which excess hardenable dental material 30 may pass when placing the filled dental crown form 10 on a prepared tooth 40 (as seen in FIG. 3). Such vents may be provided in the dental crown form 10 as packaged when provided to the practitioner or they may added by the practitioner after removing the dental crown form from the package (as described in, e.g., U.S. Pat. No. 5,951,294 to Pierson).

If the handle 20 is hollow, the tip 22 may preferably be sealed as depicted in FIGS. 1 and 2. When sealed, the handle volume is preferably not in fluid communication with the ambient air surrounding the tip 22. The sealing may be performed by any suitable technique or techniques. In the depicted embodiment, the tip 22 is molded closed during manufacturing. Other examples of sealing techniques may include, e.g., heat sealing, providing a plug within the handle, providing a cap over the exterior of the tip, etc. It may be preferred that some indicia be provided on the handle 20 or attached thereto to identify, e.g., the dental crown form itself and/or the dental restorative material located therein (if any).

The dental crown form 10 may also preferably include a mass of hardenable dental material 30 located within the body 12. It is preferred that, as delivered to a dentist or other practitioner, the hardenable dental material 30 is formable, i.e., it is capable of forming around a post or prepared tooth before being hardened. If the hardenable dental material 30 is of a type that is described as curing to a hardened state, the hardenable dental material 30 may preferably be uncured as supplied for use. Also, the hardenable dental material 30 provided in the body 12 may be limited to one type of hardenable dental material, or, alternatively, the hardenable dental material 30 may be a combination of two or more different hardenable dental materials to provide, e.g., desirable shading characteristics in a finished restored tooth and/or desirable flow behavior in the unhardened dental material.

Examples of suitable hardenable dental materials that may be used in connection with the present invention include, e.g., the photopolymerizable and chemically polymerizable compositions disclosed for use as hardenable dental materials (restoratives, fillers, etc.) as described in, e.g., U.S. patent application Ser. No. 10/185,431 filed Jun. 28, 2002 (Oxman et al.) titled PROCESSES FOR FORMING DENTAL MATERIALS AND DEVICE; as well as U.S. Pat. No. 6,084,004 (Weinmann et al.) and U.S. Pat. No. 6,187,836 (Oxman et al.).

If the dental crown forms of the present invention are pre-filled with hardenable dental materials, it may be preferred that the materials be free-radically photopolymerizable (e.g., ethylenically unsubstituted materials) or cationically photopolymerizable (e.g., epoxy resin materials). If the dental crown forms of the present invention are filled with hardenable dental materials by the practitioner (e.g., dentist), it may be suitable to use either photopolymerizable or chemically polymerizable materials. Such chemically hardenable materials are sometimes referred to as “self-cure” compositions and may include, e.g., glass ionomer cements, resin-modified glass ionomer cements, redox cure systems, and combinations thereof. Among the chemically hardenable materials, redox cure systems may be preferred for the present invention.

FIG. 3 is a cross-sectional view of the dental crown form 10 of FIGS. 1 and 2 in place over a prepared tooth 40. The prepared tooth 40 may be prepared such that an appropriate bond is formed between the hardenable dental material 30 and the prepared tooth 40. Such preparation may include, e.g., shaping, etching, priming, coating with a dental adhesive, etc.

A portion of the mass of hardenable dental material 30 in the dental crown form 10 is displaced by the prepared tooth 40 as the dental crown form 10 is moved into position. The amount of hardenable dental material 30 displaced by the prepared tooth may preferably exit from within the body 12 of the dental crown form 10 into the volume of the handle 20 through vent opening 21. To facilitate movement of the hardenable dental material 30 into the handle 20, the handle 20 may preferably be vented to the ambient atmosphere.

If the tip 22 of the handle 20 is sealed as depicted in FIGS. 1 and 2, the venting may involve removal of the tip 22 by, e.g., cutting the tip 22 with a scissors, knife, or other instrument. If the tip 22 is sealed by other techniques, then actions appropriate for that sealing technique may be employed (e.g., removal of a plug or cap from the tip, etc.).

It may be preferred that the volume of the handle 20 be selected such that the displaced hardenable dental material 30 driven from the body 12 into the handle 20 is retained within the handle 20. By retaining the displaced hardenable dental material 30 within the handle 20, a practitioner does not need to take other measures to remove the displaced material 30 from the patient's mouth. To retain the displaced hardenable dental material 30, the handle volume may preferably be 5% or more of the tooth-shaped volume of the body 12. In some instances, the handle volume may be as much as 10% or more of the tooth-shaped volume of the body.

If the handle 20 is hollow, it may include a plug 28 of, e.g., material that is capable of restricting flow of the hardenable dental material 30 through the handle 20. A plug 28 may be provided in addition to a sealed tip 22 or in place of the sealed tip 22. Examples of some suitable materials for the plug 28 may be sorbent material designed to absorb dental materials as described in, e.g., U.S. Pat. No. 5,707,236 (Swanson et al.).

With the dental crown form 10 in the desired position over the prepared tooth 40, the practitioner may have a number of options. If the hardenable dental material 30 is of a type that can retain its desired shape before hardening and after release from the interior surfaces of the dental crown form 10, the practitioner may remove the dental crown form 10 (while leaving the hardenable dental material 30 in place on the prepared tooth 40) before hardening the dental material 30. In this method, the practitioner may have an opportunity to shape the hardenable dental material 30 before hardening to, e.g., adjust occlusal, proximal, and/or marginal contacts, after which the properly shaped hardenable dental material 30 can be hardened. Following hardening, the crown (i.e., the hardened shaped dental material 30) may be removed from the prepared tooth 40 to apply any adhesive or other bonding agents needed to retain the crown on the prepared tooth 40, to trim the crown (at, e.g. the margin), to adjust the crown, to polish the crown, etc.

Alternatively, if hardening of the hardenable dental material 30 can be accomplished with the dental crown form 10 still in contact with the hardenable dental material 30, then the practitioner may harden the dental material 30 before removing the dental crown form 10 from the prepared tooth 40 (with the hardenable dental material 30 located therein). Following hardening of the dental material 30, the dental crown form 10 may be removed therefrom. Also, the hardened dental material 30 (i.e., the crown) may be removed from the prepared tooth 40 to apply any adhesive or other bonding agents needed to retain the crown on the prepared tooth 40, to trim the crown (at, e.g. the margin), to adjust the crown, to polish the crown, etc.

A potential advantage of hardening the hardenable dental material 30 while it is still in the dental crown form 10 is that exposure of the outer surface of the hardenable dental material 30 to oxygen during the hardening process may be reduced or prevented because of protection provided by the dental crown form 10. Exposure of some hardenable dental materials to oxygen during hardening may not be desired.

In yet another alternative, a practitioner may choose to partially harden the hardenable dental material 30 before removing the dental crown form 10 from the hardenable dental material 30, followed by full or complete hardening after removal of the dental crown form 10. In this embodiment, control over exposure of the outer surface of the hardenable dental material 30 to oxygen during hardening may be provided because the hardenable dental material 30 is still located within the dental crown form while the outer layer is hardened.

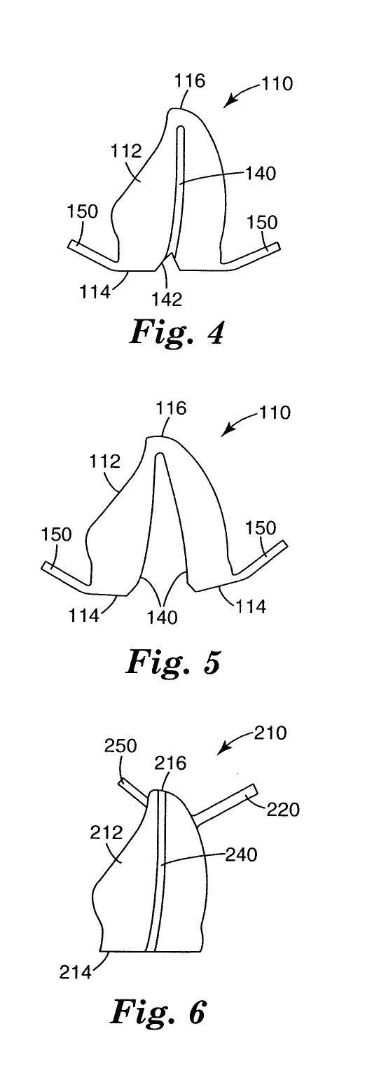

FIG. 4 is a side view of an interproximal side surface of another dental crown form 110 according to the present invention. The dental crown form 110 includes a body 112 that defines an interior tooth-shaped volume, along with a base 114 and an incisal/occlusal region 116 similar to those discussed above. The tooth-shaped volume of the body 112 may contain hardenable dental material as packaged and provided to the practitioner.

The dental crown form 110 also includes at least one line of weakness 140 formed in the body 112. Although only one line of weakness 140 is depicted in FIG. 4, a second line of weakness may preferably be provided on the opposite interproximal side surface of the dental crown form 110.

The lines of weakness 140 preferably define lines along which the body 112 may preferably separate when tension is applied across the line of weakness 140. The lines of weakness 140 may take a variety of forms, e.g., thinned lines in which the wall thickness of the body is reduced relative to the surrounding wall thickness, score lines formed after the dental crown form 110 is manufactured, lines of perforations, etc. In yet another variation, the line of weakness may be defined by a filament molded in the body 112 such that the body preferentially separates along the filament. Other variations providing a means of separation may be envisioned by those skilled in the art.

Separation of the body 112 along the one or more lines of weakness 140 may be facilitated by a variety of optional features. For example, notches 142 may be provided at the ends of the lines of weakness 140. The notches 142 may act as stress concentrators to initiate separation along the lines of weakness 140.

The dental crown form 10 may also include tabs 150. The tabs 150 may be used to both facilitate manipulation of the dental crown form during placement on a prepared tooth and to provide a location at which the dental crown form may be gripped to apply the force required to separate the one or more lines of weakness in the body 112. As such, it may be preferred to provide two or more tabs 150 on opposite sides of the base 114 of the body 112 as depicted in FIGS. 4 and 5. The tabs 150 may alternatively be located at a position removed from the base 114. Some indicia may be included on the tabs 150 or attached thereto to identify, e.g., the dental crown form itself and/or the hardenable dental material located therein (if any).

It may be preferred that the body 112 include two lines of weakness 140 such that the dental crown form 110 can open in a clamshell manner as depicted in FIG. 5. It may be further preferred that the lines of weakness 140 be located on the interproximal side surfaces of a dental crown form 110 as shown to facilitate the clamshell opening procedure.

FIG. 6 depicts another illustrative embodiment of a dental crown form 210 including a handle 220 extending from one side of the body 212 and tab 250 extending from the opposite side of the body 212. The handle 220 may preferably be hollow and in fluid communication with the tooth-shaped volume defined within the body 212 such as described in connection with the embodiment depicted in FIGS. 1-3.

The dental crown form 210 also preferably includes a line of weakness 240 that extends between the handle 220 and the tab 250 through, e.g., the incisal/occlusal region 216, and preferably extends to the base 214 of the body 212. As such, the handle 220 and the tab 250 can be grasped to apply tension across the line of weakness 240, causing the body 212 of the dental crown form 220 to separate along the line of weakness 240. It will be understood that some variations which could be introduced in the design of the dental crown form 210 include, e.g., replacing the handle 220 by a second tab such that the dental crown form 210 includes two opposing tabs separated by a line of weakness, with the tabs preferably being located proximate the incisal/occlusal region of the dental crown form 210. In another alternative, the tab 250 could be replaced by a second handle that may or may not be hollow.

FIG. 7 is a cross-sectional view of another dental crown form 310 according to the present invention. The dental crown form 310 includes a body 312, a base 314 and an incisal/occlusal region 316, as well as a pair of opposing tabs 350 similar to the dental crown form 210 described above. The dental crown form 310, however, also includes a liner 360 located within the body 312. As depicted in FIG. 7, the dental crown form 310 includes a mass of hardenable dental material 330 located therein and is in place over a prepared tooth 340.

The liner 360 may provide a number of different optional features. It may be preferred that the liner 360 has a composition such that adhesion of any hardenable dental material located within the dental crown form 310 is limited or non-existent. For example, the liner 360 may include low surface energy materials such as PTFE, silicone, etc. to limit or prevent adhesion with the hardenable dental material 330 located in the dental crown form 310. The liner 360 may or may not be affixed to the interior of the body 312 of the dental crown form 310.

If the liner 360 is not attached to the interior surface of the body 312, the body 312 may be removed from the liner 360 after the dental crown form 310 is located over the prepared tooth 340, leaving the liner 360 in place over the hardenable dental material 330 and the prepared tooth 340. If the hardenable dental material 330 is photocurable or photopolymerizable, the body 312 may preferably function as an actinic light barrier to provide protection from actinic radiation that may otherwise prematurely harden the hardenable dental material 330 in the dental crown form 310. For example, body materials that are an actinic light barrier may preferably transmit less than 1% of actinic radiation incident thereon into the tooth-shaped volume of the body 312.

It may also be preferred that the liner 360 be flexible. If the liner 360 is flexible and is not attached to the interior of the body 312, then it may be possible to remove the body 312 while leaving the liner 360 in place over the hardenable dental material 330. If the liner 360 is flexible, it may be possible to shape the underlying hardenable dental material 330 before removing the liner 360 to, e.g., adjust occlusal, proximal, and/or marginal contacts, after which the shaped hardenable dental material 330 can be hardened. After shaping the hardenable dental material 330, the liner 360 may be removed before or after hardening of the hardenable dental material 330. If, however, the liner 360 is retained on the hardenable dental material 330 until it is at least partially hardened, the outer surface of the hardenable dental material 330 may be protected from exposure to oxygen during the hardening process. If the liner 360 is to be left in place during hardening and the hardenable dental material 330 is photocurable, then it will typically be preferred that the liner 360 be transmissive for actinic radiation required to harden the hardenable dental material 330. By transmissive, it may be sufficient that the liner transmit only 25% or more (preferably 50% or more) of the actinic radiation incident thereon.

Following hardening, the crown (i.e., the hardened shaped dental material 330) can be removed from the prepared tooth 340 to apply any adhesive or other bonding agents needed to retain the crown on the prepared tooth 340 (unless the hardenable dental material 330 is, itself, capable of sufficiently bonding to the prepared tooth 340).

In another variation, the inner surface of the body 312 of the dental crown form 310 may be coated with a release material designed to limit adhesion between any hardenable dental material 330 and the body 312. In place of or in addition to a release coating, the body 312 itself may be manufactured of materials that provide limited adhesion with any hardenable dental material located within the body 312.

FIG. 8 is a view of an interproximal side surface of the dental crown form 310. As noted above, the dental crown form 310 includes a body 312, base 314 and incisal/occlusal region 316, as well as tabs 350. FIG. 8 also depicts a line of weakness 340 formed in the body of the dental crown form 310, with the line of weakness 340 including a notch 342 and perforations 344 formed through the body 312, with each of the perforations being separated by a land portion. It may be preferred that the perforations 344 be formed as voids through the body 312, but that the underlying liner 360 not be perforated. If the liner 360 is not perforated, it may operate to more effectively contain any hardenable dental material therein, as well as protect the hardenable dental material from exposure to oxygen during hardening, etc. The line of weakness 340 may preferably extend over the mesio-inciso-distal line of the dental crown form 310.

FIG. 9 is a schematic diagram depicting another concept that may be embodied in the dental crown forms of the present invention. As discussed above, it may be beneficial to provide a dental crown form 410 with a mass of hardenable dental material 430 sealed therein when sent to the practitioner (although it should be understood that the dental crown forms of the present invention can be filled with a hardenable dental material by the practitioner before placement over a prepared tooth). Because hardenable dental materials are typically not stable enough to be exposed to atmosphere for long periods of time, the dental crown form 410 provided with hardenable dental material 430 located therein may preferably be located within a package 460 as provided to the practitioner.

The package 460 may take the form of any suitable structure, e.g., envelope, blister pack, etc. known in the packaging arts. Examples of some suitable packaging materials may be described in U.S. Pat. No. 5,538,129 (Chester et al.); U.S. Pat. No. 5,552,177 (Jacobs et al.); U.S. Pat. No. 5,636,736 (Jacobs et al.); and U.S. Pat. No. 5,785,178 (Kvitrud et al.), etc.

The package 460 may preferably provide any characteristics required to maintain the working properties of the hardenable dental material 430 in the dental crown form 410. For example, the package 460 may provide hermetically sealed volumes containing one or more pre-filled dental crown forms (where a pre-filled dental crown form is a dental crown form containing a mass of hardenable dental material). If the hardenable dental material 430 is photocurable or photopolymerizable, the package 460 may also preferably function as an actinic light barrier to provide protection from actinic radiation that may otherwise prematurely harden the hardenable dental material 430 in the dental crown form 410. For example, package materials that are an actinic light barrier may preferably transmit less than 1% of actinic radiation incident thereon into the interior of the package 460.

All references and publications cited herein are expressly incorporated herein by reference in their entirety into this disclosure. Illustrative embodiments of this invention are discussed and reference has been made to possible variations within the scope of this invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A dental crown form comprising:
a body defining a tooth-shaped volume, the body comprising a base and an incisal/occlusal region distal from the base;
hardenable dental material located within the tooth-shaped volume; and
a handle attached to the body at a location removed from the base.

2. A dental crown form according to claim 1, wherein the handle is attached to the body at a location that is closer to the incisal/occlusal region than the base.

3. A dental crown form according to claim 1, wherein the handle comprises a hollow handle, wherein the hollow handle defines a handle volume that is in fluid communication with the tooth-shaped volume of the body through a vent opening formed in the body.

4. A dental crown form according to claim 3, wherein the handle comprises a hollow tubular handle.

5. A dental crown form according to claim 3, wherein the handle comprises a sealed tip distal from the body.

6. A dental crown form according to claim 3, wherein the handle volume is 5% or more of the tooth-shaped volume.

7. A dental crown form according to claim 1, wherein the dental crown form is located within a hermetically sealed package.

8. A dental crown form according to claim 1, wherein the dental crown form is located within an actinic light barrier package.

9. A dental crown form comprising:
a body defining a tooth-shaped volume, the body comprising a base and an incisal/occlusal region distal from the base;
hardenable dental material located within the tooth-shaped volume;
a hollow handle attached to the body at a location that is closer to the incisal/occlusal region than the base, wherein the handle defines a handle volume that is in fluid communication with the tooth-shaped volume of the body through a vent opening formed in the body.

10. A dental crown form according to claim 9, wherein the handle volume is 5% or more of the tooth-shaped volume.

11. A dental crown form according to claim 9, wherein the dental crown form is located within a hermetically sealed package.

12. A dental crown form according to claim 9, wherein the dental crown form is located within an actinic light barrier package.

13. A dental crown form comprising:
a body defining a tooth-shaped volume, the body comprising a base and an incisal/occlusal region distal from the base; and
a hollow handle attached to the body at a location removed from the base, wherein the hollow handle is in fluid communication with the tooth-shaped volume through a vent opening formed in the body.

14. A dental crown form according to claim 13, further comprising hardenable dental material located within the tooth-shaped volume.

15. A dental crown form according to claim 14, wherein the dental crown form is located within a hermetically sealed package.

16. A dental crown form according to claim 14, wherein the dental crown form is located within an actinic light barrier package.

17. A dental crown form according to claim 13, wherein the handle is attached to the body at a location that is closer to the incisal/occlusal region than the base.

18. A dental crown form according to claim 13, wherein the handle volume is 5% or more of the tooth-shaped volume.

19. A dental crown form comprising:
a body defining a tooth-shaped volume, the body comprising a base and an incisal/occlusal region distal from the base; and
one or more lines of weakness formed in the body.

20. A dental crown form according to claim 19, wherein each line of weakness of the one or more lines of weakness comprises a notch formed at one end thereof.

21. A dental crown form according to claim 19, wherein each line of weakness of the one or more lines of weakness extends from proximate the base towards the incisal/occlusal region of the body.

22. A dental crown form according to claim 19, wherein the one or more lines of weakness comprises only one line of weakness extending from proximate the base on one side of the body, over the incisal/occlusal region, and terminating proximate the base of an opposing side of the body.

23. A dental crown form according to claim 19, further comprising a release coating on an inner surface of the of the body.

24. A dental crown form according to claim 19, further comprising a liner located within the body of the dental crown form.

25. A dental crown form according to claim 24, wherein the one or more lines of weakness comprise one or more perforations formed through the body.

26. A dental crown form according to claim 24, wherein the dental crown form further comprises photocurable hardenable dental material located within the tooth-shaped volume of the body, and wherein the liner is transmissive to actinic radiation capable of hardening the photocurable hardenable dental material.

27. A dental crown form according to claim 26, wherein the body comprises an actinic light barrier to the actinic radiation capable of hardening the photocurable hardenable dental material.

28. A dental crown form according to claim 19, further comprising one or more tabs attached to the body.

29. A dental crown form according to claim 19, further comprising two tabs attached to the body, wherein the two tabs are located on opposing sides of the body.

30. A dental crown form according to claim 29, wherein the two tabs are attached to the body proximate the base.

31. A dental crown form according to claim 29, wherein the two tabs are attached to the body proximate the incisal/occlusal region.

32. A dental crown form according to claim 19, further comprising a hollow handle attached to the body, wherein the hollow handle is in fluid communication with the tooth-shaped volume through a vent opening formed in the body.

33. A dental crown form according to claim 32, wherein the handle is attached to the body at a location closer to the incisal/occlusal region than the base.

34. A dental crown form according to claim 32, wherein the handle volume is 5% or more of the tooth-shaped volume.

35. A dental crown form according to claim 19, wherein the dental crown form further comprises hardenable dental material located within the tooth-shaped volume and is located within a hermetically sealed package.

36. A dental crown form according to claim 19, wherein the dental crown form further comprises hardenable dental material located within the tooth-shaped volume and is located within an actinic light barrier package.

37. A method of providing a dental crown, the method comprising:
providing a dental crown form that comprises a body defining a tooth-shaped volume, the body comprising a base and an incisal/occlusal region distal from the base, wherein the dental crown form further comprises a handle attached to the body at a location removed from the base;
providing hardenable dental material located within the tooth-shaped volume of the body of the dental crown form;
locating the dental crown form over a prepared tooth;
hardening the hardenable dental material to form a dental crown; and
removing the dental crown form.

38. A method according to claim 37, wherein the handle is attached to the body at a location that is closer to the incisal/occlusal region than the base.

39. A method according to claim 37, wherein the handle comprises a hollow handle defining a handle volume that is in fluid communication with the tooth-shaped volume of the body through a vent opening formed in the body, and wherein the method further comprises forcing a portion of the hardenable dental material into the handle volume when locating the dental crown form over the prepared tooth.

40. A method according to claim 39, wherein substantially all of the hardenable dental material is retained within the body or the hollow handle after locating the dental crown form over the prepared tooth.

41. A method according to claim 39, wherein the handle comprises a sealed tip distal from the body, and further wherein the method comprises venting the sealed tip before locating the dental crown form over the prepared tooth.

42. A method according to claim 37, wherein the method comprises removing the dental crown form before hardening the hardenable dental material.

43. A method according to claim 42, further comprising shaping the hardenable dental material after removing the dental crown form and before hardening the hardenable dental material.

44. A method according to claim 37, wherein the method comprises removing the dental crown form after at least partially hardening the hardenable dental material.

45. A method according to claim 37, further comprising removing the dental crown form from a hermetically sealed package with the hardenable dental material located within the tooth-shaped volume of the body before the dental crown form is removed from the package.

46. A method according to claim 37, further comprising removing the dental crown form from an actinic light barrier package with the hardenable dental material located within the tooth-shaped volume of the body before the dental crown form is removed from the package.

47. A method of providing a dental crown, the method comprising:
providing a dental crown form that comprises a body defining a tooth-shaped volume, the body comprising a base and an incisal/occlusal region distal from the base, the dental crown form further comprising one or more lines of weakness formed in the body;
providing hardenable dental material located within the tooth-shaped volume of the body of the dental crown form;
locating the dental crown form over a prepared tooth;
hardening the hardenable dental material to form a dental crown; and
removing the dental crown form by separating the one or more lines of weakness.

48. A method according to claim 47, wherein the method comprises removing the dental crown form before hardening the hardenable dental material.

49. A method according to claim 48, further comprising shaping the hardenable dental material after removing the dental crown form and before hardening the hardenable dental material.

50. A method according to claim 47, wherein the dental crown form further comprises a liner located within the body, the liner positioned between the body and the hardenable dental material, wherein removing the dental crown form comprises simultaneously removing the liner.

51. A method according to claim 50, wherein the one or more lines of weakness comprise one or more perforations formed through the body.

52. A method according to claim 47, wherein the dental crown form further comprises a liner located within the body, the liner positioned between the body and the hardenable dental material, wherein the liner remains on the dental material after removing the dental crown form.

53. A method according to claim 52, wherein the method comprises removing the liner before hardening the hardenable dental material.

54. A method according to claim 52, further comprising shaping the hardenable dental material after removing the liner and before hardening the hardenable dental material.

55. A method according to claim 52, further comprising shaping the hardenable dental material before removing the liner and before hardening the hardenable dental material.

56. A method according to claim 52, wherein the hardenable dental material comprises a photocurable material, and wherein the liner transmits actinic radiation capable of hardening the hardenable dental material.

57. A method according to claim 47, wherein each line of weakness of the one or more lines of weakness comprises a notch formed at one end thereof.

58. A method according to claim 47, wherein each line of weakness of the one or more lines of weakness extends from proximate the base towards the incisal/occlusal region of the body.

59. A method according to claim 47, wherein the one or more lines of weakness comprises only one line of weakness extending from proximate the base on one side of the body, over the incisal/occlusal region, and terminating proximate the base of an opposing side of the body.

60. A method according to claim 47, further comprising one or more tabs attached to the body, wherein removing the dental crown form comprises grasping the one or more tabs to separate the one or more lines of weakness.

61. A method according to claim 47, further comprising two tabs attached to the body, wherein the two tabs are located on opposing sides of the body, and wherein removing the dental crown form comprises grasping the two tabs to separate the one or more lines of weakness.

62. A method according to claim 47, wherein the method comprises removing the dental crown form after at least partially hardening the hardenable dental material.

63. A method according to claim 47, wherein the dental crown form further comprises a hollow handle defining a handle volume that is in fluid communication with the tooth-shaped volume of the body through a vent opening formed in the body, and wherein the method further comprises forcing a portion of the hardenable dental material into the handle volume when locating the dental crown form over the prepared tooth.

64. A method according to claim 63, wherein substantially all of the hardenable dental material is retained within the body or the hollow handle after locating the dental crown form over the prepared tooth.

65. A method according to claim 47, wherein the method comprises removing the dental crown form after at least partially hardening the hardenable dental material.

66. A method according to claim 47, further comprising removing the dental crown form from a hermetically sealed package with the hardenable dental material located within the tooth-shaped volume of the body before the dental crown form is removed from the package.

67. A method according to claim 47, further comprising removing the dental crown form from an actinic light barrier package with the hardenable dental material located within the tooth-shaped volume of the body before the dental crown form is removed from the package.
